(19) United States
(12) Patent Application Publication
(10) Pub. No.: US 2006/0068787 A1
(43) Pub. Date: Mar. 30, 2006

(54) Patron service allocation

(76) Inventors: Nikhil M. Deshpande, Beaverton, OR (US); Uttam K. Sengupta, Portland, OR (US); Robert Knauerhase, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/957,275

(22) Filed: Sep. 30, 2004

(51) Int. Cl. H04Q 7/20

(52) U.S. Cl. 455/435.3

(57) ABSTRACT

Opportunistic and proactive scheduling of service establishment services can be performed, in part, by tracking customer availability to receive a service. For example, assuming a service establishment maintains a wait-list for a certain service, customers can be monitored to determine whether they appear available to receive their service at their allotted time, e.g., when their turn is predicted coming due based on predicted service availability. If the customer is determined not available, such as due to some obstacle preventing receiving service, the service establishment may re-prioritize one or more customers in the wait-list to take advantage of other customer availability. A wireless device associated with the customer and providing at least location data may be used at least in part to help determine customer availability.

### RELATED APPLICATIONS

This application is related to co-pending application Ser. No. 10/816,401, bearing attorney docket number P19078, filed on Mar. 31, 2004, entitled “Transmission Of Service Availability Information,” and which is commonly assigned to the assignee of the present invention.

### FIELD OF THE INVENTION

The invention generally relates to communication of service availability status information to a waiting customer and improving provision of service by a service provider. More particularly, embodiments of the invention relate to adjusting information (e.g., scheduling information) related to service availability based on a determined location for a waiting/potential customer using wireless communication.

### BACKGROUND

When attempting to obtain services from a service establishment, such as one allowing “walk in” customers, e.g., where one may obtain services without a prior reservation or appointment (e.g., restaurant, hair dresser, entertainment, amusement park, etc.), a potential customer may be informed of a waiting period before the customer can receive a desired service. If a customer wishes to obtain the service, the customer may add his name to a waiting list and then determine what to do during the waiting period.

Some establishments provide a wireless device to notify a customer when a desired service (or services) is available, thus no longer requiring the customer to wait on the establishment's premises. Historically, these wireless devices suffer from multiple disadvantages; for example, they are typically single purpose and limited in range, e.g., typically they respond to a short-range signal transmitted from the establishment providing the desired service, thus requiring the customer to stay proximate to the establishment. Some attempts have been made to improve the proximity limitation by adopting technology, such as pagers, that allow a customer to wander about a much larger area.

Unfortunately, this freedom of movement creates incident problems with scheduling since there may be significant delays between signaling a customer that their turn has arrived, and that customer's ability to return to the establishment to partake of the desired service. These delays can result in services going unused when they could in fact be allocated to a customer immediately available, e.g., one waiting within the establishment. This can have a detrimental effect on ability of an establishment to provide a satisfactory service to its customers.

### BRIEF DESCRIPTION OF THE DRAWINGS

The features and advantages of the present invention will become apparent from the following detailed description of the present invention in which:

FIG. 1 illustrates an exemplary architecture according to one embodiment utilizing customer availability data when providing service availability information.

FIG. 2 illustrates an exemplary flow diagram according to one embodiment for providing service availability information to a customer via a device associated with the customer.

FIG. 3 illustrates a block diagram according to one embodiment of an electronic system having a scheduling agent.

FIG. 4 illustrates a block diagram according to one embodiment of an electronic system having a service availability agent.

FIG. 5 illustrates a block diagram of a wireless device according to one embodiment.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

The techniques and devices described herein may distribute service availability information (or other information) to one or more waiting customers using a wireless device to benefit both the customer and to the service establishment. In some embodiments, the wireless device may track a customer's location, travel pattern, rate of travel towards the service establishment, travel obstacles, etc. (collectively “location data”), where location data may be used at least in part to adjust service information distribution based at least in part on a determined or estimated ability of a customer to receive a desired service(s) (“customer availability”). The location of a customer may be determined by any type of location-aware technology, including, for example, Global Position System (GPS), triangulation techniques, directional transmission, extrapolation off known positions for other machines or devices proximate to the customer, etc.

Benefits to a waiting customer include, for example, a wider selection of activities that are available during the waiting period, greater information regarding the availability of services and/or the ability to reschedule services. Benefits to the service establishment may include, for example, increased efficiency in providing limited services, as waiting queues may be re-ordered based on customer availability, increased customer satisfaction and/or increased opportunities for word of mouth advertising from the waiting customer.

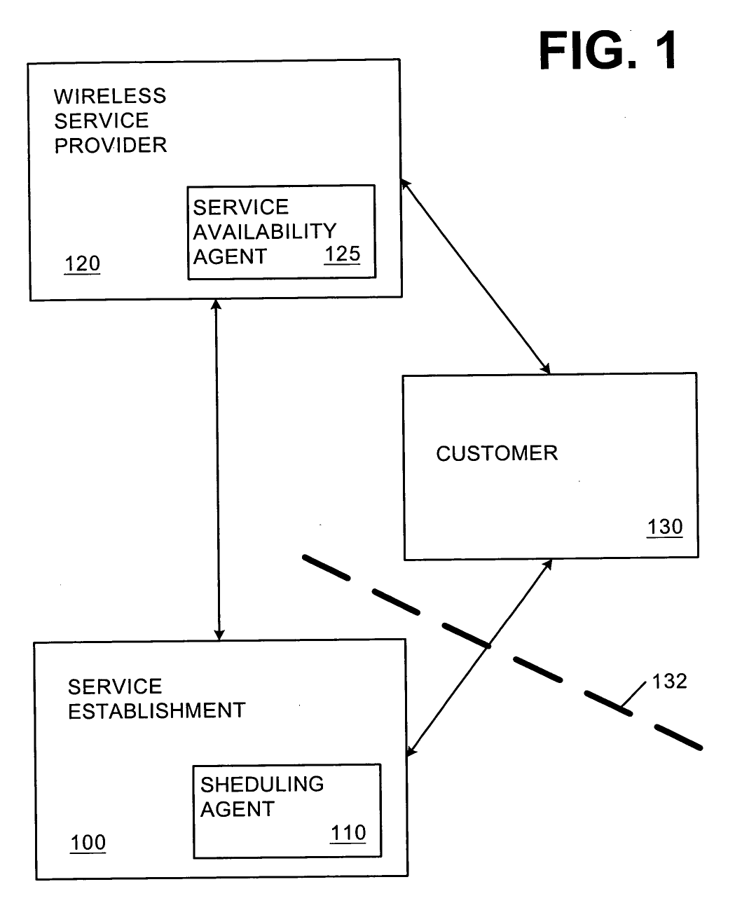

FIG. 1 illustrates an exemplary architecture according to one embodiment utilizing customer availability data when providing service availability information using single or multi-purpose wireless devices. Service establishment 100 may be any type of establishment that provides goods and/or services to a customer without requiring reservations for all customers. Service establishment 100 may be, for example, a restaurant, a hair salon, an automobile service facility, an amusement park (or individual attractions therein), a spa, a bar, a club, a golf course, a bowling facility, a tennis court, a theatre or other entertainment facility, etc.

In one embodiment, service establishment 100 may have an electronic scheduling capability (“scheduling agent”) 110. For example, in a restaurant context, the scheduling agent 110 may incorporate seating and scheduling software for patrons. As described in greater detail below, scheduling agent 110 may be any combination of hardware and software operating on a singled machine or in a distributed collection of machines cooperatively operating. In one embodiment, scheduling agent 110 may communicate with one or more wireless service providers to selectively provide and/or forward scheduling information or other data for service establishment 110 to customer 130 by wireless service provider 120. For expository convenience, only one wireless service provider 120 is illustrated. It will be appreciated communication with wireless service providers may be bidirectional or a data push and/or pull system.

Wireless service provider 120 may be, for example, a cellular telephone service provider, a paging service provider, a wireless Internet service provider, a wireless “hotspot” (e.g., a store or other location providing access to a network such as the Internet over a wired and/or short or long range wireless communication medium), or the like. In the illustrated embodiment, wireless service provider 120 may receive scheduling information from scheduling agent 110 and use received scheduling information to provide service availability information to a device associated with the customer (“associated device”), such as a device belonging to, carried by, or otherwise proximate to or associated with customer 130. In another embodiment (not illustrated) service establishment 100 may incorporate wireless service provider 120, e.g., a restaurant may have its own wireless transceiver equipment using standard and/or proprietary wireless protocols for communicating with customer 130.

In one embodiment, customer 130 may receive service availability information from wireless service provider 120 using any device capable of receiving various types of information, for example, a cellular telephone, a pager, a personal digital assistant (PDA), a portable computer, a global positioning system (GPS) device, a watch (e.g., a clock), a wireless electronic mail device, etc. A wireless device may also be, for example, an automobile or other transportation device carrying customer 130. The phrase “wireless device” is intended to refer broadly to any machine or device capable of receiving service availability information for a customer, and the phrase “associated device” discussed above, is intended to include these wireless device possibilities. It will be appreciated that any wireless communication protocol presently known in the art or developed in future may be used to communicate information from wireless service provider 120 and the wireless device corresponding to customer 130.

In one embodiment, while waiting for a desired service, customer 130 may travel away from the service establishment 100, where doing so results in one or more obstacles represented by dashed line 132 that must be addressed before customer 130 may return to the service establishment. For example, exemplary obstacles include a driving distance to the service establishment, driving conditions, weather conditions, traffic conditions, etc., as well as customer movement pattern and rate of movement, e.g., does movement indicate heading directly or indirectly towards the service establishment, or heading away, circling, is customer moving quickly, slowly, etc.

The term “obstacle” is intended to include any condition, event, or situation preventing or delaying a customer's immediate receipt of a desired service. In one embodiment, an estimated time of arrival (ETA) may be predicted for customer 130 based at least in part on the position of service establishment 100 and a customer's availability. In one embodiment, customer availability describes to what extent a customer is able or available to receive a service, while an ETA describes an estimate of when the customer will be available to receive the service. As will be discussed below, the ETA and or customer availability may be used to adjust service provision dynamically based on perceived customer ability to arrive at the service establishment to receive the desired service. It will be appreciated various weightings and times may be associated with the information used to determine an ETA, and hence similar circumstance in different locations may result in different ETAs.

While the architecture of FIG. 1 is described in terms of a service establishment providing service availability information to a wireless service provider for informing the customer, it will be appreciated alternate architectures without wireless service providers can also be used.

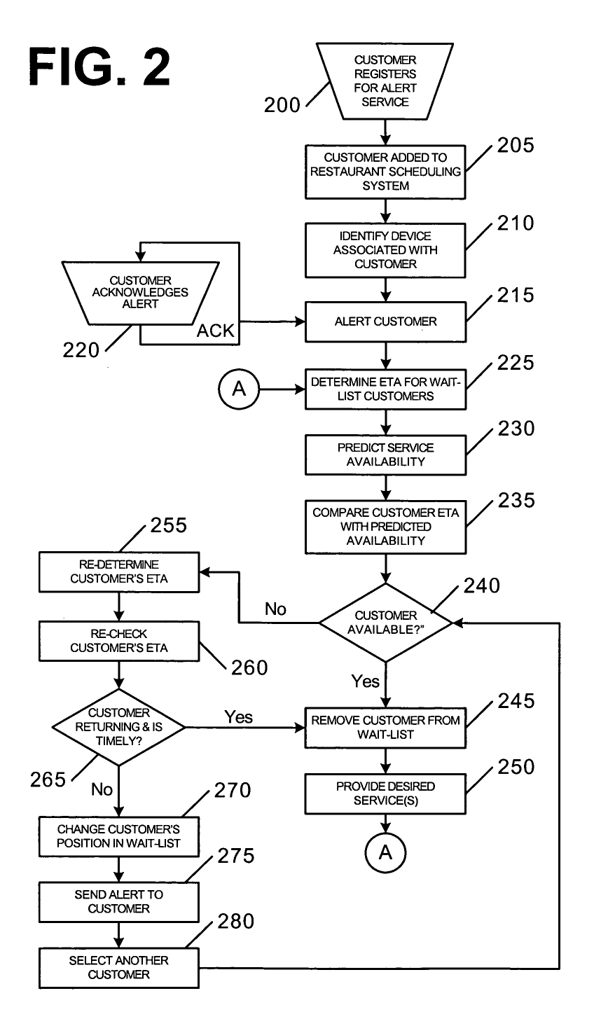

FIG. 2 illustrates an exemplary flow diagram according to one embodiment for providing service availability information to a customer via a device associated with the customer (“associated device”), such as a wireless device. As discussed above, in some embodiments, service availability may be determined at least in part on obstacles preventing or delaying a customer's ability to receive a desired service. It should be appreciated that the examples of FIG. 2 may include optional features desirable for certain embodiments of the invention, but that are not necessary or are optional for other embodiments of the invention. Also, while examples of FIG. 2 are often provided in terms of a customer waiting for a table at a restaurant, as discussed above, the illustrated techniques, devices and related descriptions are applicable to a broad range of service establishments.

A customer having a wireless device (or other associated device) may initially register 200 for alert services. According to one exemplary embodiment, such registration need not require any particular action on behalf of the user, but may be, for example, automatic or inherent in a service agreement. As described in greater detail below, alert services may also include tracking a customer's ETA. Alerts can be provided, for example, by a wireless service provider as part of a wireless communications service with a wireless device. In some embodiments, a customer may have one device to track the customer's location, where alerts are provided to another device or devices proximate to the customer's location, e.g., a store announcement system, public television or other display, transportation vehicle, etc. may be used to alert the customer. Registration may occur any time before use of the alert services. That is, a user may register for alert services when purchasing a cellular telephone, by filling out a preference questionnaire, e.g., printed or electronic form, etc., or a user may register for alert services when engaging a service establishment offering a particular service desired by the customer, e.g., when adding oneself to a wait-list.

After or along with registering 200, a customer may be added 205 to a scheduling system, e.g., a restaurant scheduler. In one embodiment, when adding 205 to the scheduling system, a device associated with the customer, e.g., a cellular telephone, communicating watch (clock), wireless personal digital assistant (PDA), device provided by the service establishment, etc., is identified 210. Identification may be of a particular device where communication arrangements are determined for the identified device, or identification may be of an identifier for communication with the associated device, e.g., a wireless network address, an electronic mail address, a pager number, a cellular phone number, etc.

In one embodiment, the associated device automatically identifies itself to the service provider, e.g., the associated device may engage in an automatic registration with a scheduling system. In one embodiment, along with identifying the associated device, a customer may also provide restrictions or preferences (generally “service requirements”) affecting how the desired service should be provided. For example, in a restaurant context, a customer may indicate a number of people in a party, seating preferences (e.g., food preferences, smoking/non-smoking, table/booth), etc. It will be appreciated these are exemplary restrictions and other and/or different information can be provided when a customer is added 205.

The customer may not be required to be present at the service provider when providing information to the service provider. For example, a customer may call a restaurant, for example, using a cellular telephone and be added to the scheduling system as a waiting customer. In one embodiment, caller-ID and/or other data provided by the cellular telephone or telephony system may be automatically provided to the service provider and used in adding 205 the customer to the scheduling system. In this embodiment, the cellular telephone may be used to provide service availability information to the customer. In another embodiment, a PDA may be used to send an electronic message to a service provider and identification data for the customer provided along with the electronic message may be used in adding 205 the customer.

In one embodiment, customer reservation information may be sent to a customer alerting system which can then provide service availability information to a customer using the associated device registered for alerting services. It will be appreciated the customer alerting system may be part of the service establishment, e.g., the service establishment may send customer reservation information directly to the customer. It will be appreciated that customer reservation information may include various data, including an identifier for the associated device, a current estimated wait time, location coordinates of the restaurant, etc. Other and/or different information can be included in the customer reservation information. The customer alerting system may periodically send updated customer reservation information.

In one embodiment, an initial alert including some or all of the current customer reservation information is sent 215 to the customer's associated device. This initial alert informs that the customer's reservation is active in the scheduling system. The initial alert may also allow the customer to select additional services and/or features, for example, a travel directory service can be provided based on the customer's travel/location changes. In one embodiment, the customer may acknowledge 220 the alert. Acknowledgement may include a request for additional and/or optional features identified in the alert. In one embodiment, acknowledgment enables the customer alerting system to determine whether the customer's associated device is functioning properly.

In one embodiment, the initial alert includes an initial estimated wait time provided by the service establishment for the customer. If the customer's associated device supports a countdown timer, then the associated device may initiate a countdown based on the provided estimated wait time so the customer is aware of when to return to the service establishment. However, subsequent alerts from the service establishment may include data that causes the customer's timer to readjust. For example, assume the service establishment receives (by any means) location data for its customers and determines 225 estimated times of arrival (ETAs) for them and compares this to predicted 230 service availability, e.g., in a restaurant context the restaurant can estimate when various tables are estimated to become available. It will be appreciated that although predicted 230 availability is illustrated as occurring after determining 225 ETAs, there is no requirement these or other illustrated operations occur in their illustrated order, and in fact, the illustrated exemplary operations may occur in parallel or in an order different than that shown.

The service establishment may then compare 235 the determined 225 ETAs and predicted 235 service availability, and based at least in part on this comparison, the service establishment may choose to re-order its wait-list to improve service availability for its customers. Thus, for example, if a first customer is next on the wait-list with a 5 minute wait remaining, but the service establishment determines the first customer has a 35 minute ETA due to one or more obstacles between the customer and the service establishment, and a second customer has a 15 minute wait remaining but only a 1 minute ETA, the service establishment may evaluate if 240 the first customer really is available to receive its desired service, or whether the service should be provided instead to the second customer that is more readily available. If 240 the customer is available, then the customer may be removed 245 from the wait-list and the desired service(s) provided 250.

If 240 the customer does not appear available to receive its desired service, e.g., an obstacle or obstacles may prevent the customer from receiving a desired service within the expiration of its wait-time, before providing the service to a different customer, the service establishment may optionally re-determine 255 and re-check 260 the customer's ETA and check if 265 the customer appears to be returning to the service establishment in a sufficiently timely manner. It will be appreciated that “sufficiently timely” may be a flexible calculation based on many factors, including current work load of the service establishment, how late the customer is estimated to be, scarcity of the service, the customer's service requirements, etc. If 265 the return is deemed timely, when the customer returns, then the customer may be removed 245 from the wait-list and the desired service(s) provided 250.

If 265 the customer does not appear to be returning to the service establishment in a sufficiently timely manner, for example, the customer's location data indicates a travel pattern away from the service establishment, or the customer is returning but slowly, perhaps due to an obstacle, then the service establishment may change 270 the customer's position in the wait-list. Alternatively, in addition to, or perhaps instead of moving the customer's position in the list, other customers' positions in the wait-list may be moved. It will be appreciated various factors may be used to determine a new wait-list position, including a customer's ETA, expected duration of providing the service to customers, general service agreements and/or particular service agreements with the customer, etc. Assuming a customer's wait-list position changes, an alert is sent 275 to indicate the change. Thus, various embodiments may opportunistically re-arrange the wait-list based at least in part on customer availability.

It will be appreciated various data may be provided in the alert to the customer regarding its position in the wait-list, such as a revised estimated wait time provided by the service establishment for the customer. Various approaches may be used to determine the revised wait-time, including simply setting it to the customer's current ETA. The alert may also send other data, such as a position indicator identifying the customer's position in the waiting queue, or a listing of some or all of the names on the wait-list, e.g., perhaps only the portion of the list near the customer's position are provided. In one embodiment, receiving the alert results in resetting a counter maintained by the customer's associated device, e.g., a wireless device.

The service establishment may then select 280 another customer, e.g., the next customer on the wait-list, and in one embodiment, processing repeats with checking if 240 that selected customer is available to receive the desired services. In one embodiment (not illustrated), if 240 the next customer is available, an alert is sent to the next customer's associated device identifying new service availability data.

In the illustrated embodiment, after providing 250 a desired service, processing loops back to determining 225 ETAs for wait-list customers. It will be appreciated other actions not illustrated may be taken as well. Further, since multiple desired services may contemporaneously become available, some or all of the illustrated operations may be practiced in parallel, e.g., in a restaurant context, multiple tables might become available and customer seating from the wait-list figured out for each of the tables.

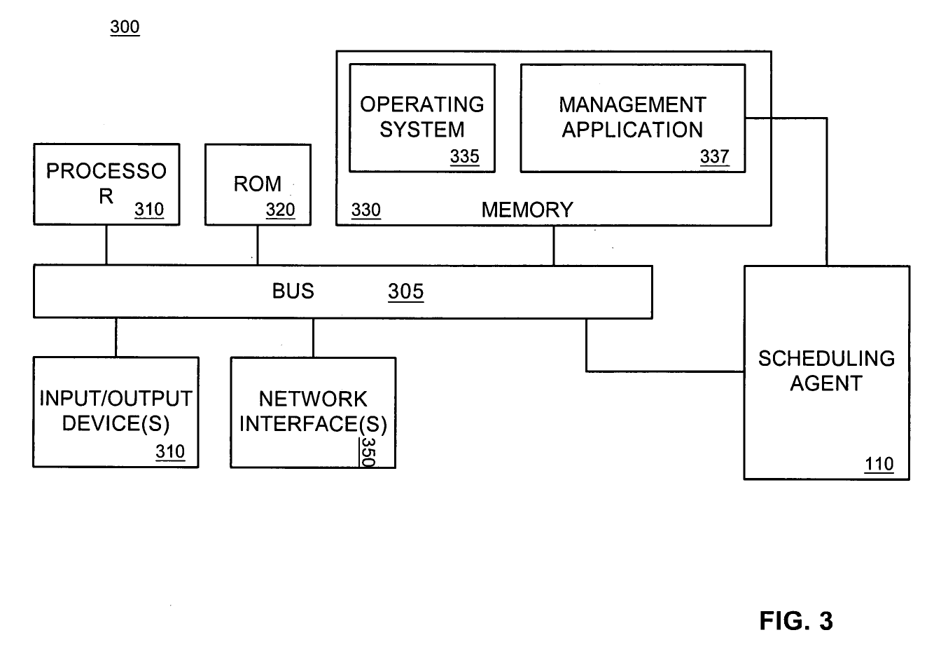

FIG. 3 illustrates a block diagram according to one embodiment of an electronic system having a scheduling agent that can be used by a service establishment to provide service availability information to a customer via a wireless device. The electronic system illustrated in FIG. 3 is intended to represent a range of electronic systems including, for example, computer systems. Alternative electronic systems can include more, fewer and/or different components. The electronic system of FIG. 3 can be, for example, a computer system in a restaurant that is used for table scheduling or other restaurant management purposes. In other types of service establishments (i.e., other than restaurants), the electronic system and scheduling agent can provide other scheduling and/or management functionality specific to the type of service establishment in which the system may be used.

Electronic system 300 includes bus 305 or other communication device to communicate information, and processor 310 coupled to bus 305 to process information. While electronic system 300 is illustrated with a single processor, electronic system 300 can include multiple processors and/or co-processors. Electronic system 300 further includes read-only memory (ROM) or other static storage device 320, coupled to bus 300. Electronic system 300 further includes input/output (I/O) device(s) 340 for receiving input data and/or signals and for providing output signals. I/O device(s) 340 can include, for example, a keyboard, a mouse, a touch screen, a liquid crystal display, a cathode ray tube, a wireless interface, or any other type of I/O device known in the art. Network interface(s) 350 provides an interface to one or more networks (not shown in FIG. 3) that are external to electronic system 300. Network interface(s) 350 can be, for example, an Ethernet interface, a wireless local area network interface, etc. Electronic system 300 also includes memory 330 coupled with bus 305. As used herein, the term “memory” is intended to encompass any currently known or future designed technique for preserving state. Thus, for example, memory 330 can include any combination of volatile and/or non-volatile memory or storage devices and their associated storage media, including random access memory (RAM), read only memory (ROM), cache memories, static or dynamic memory or other state preserving medium, including hard-drives, floppy-disks, optical storage, tapes, flash memory, memory sticks, digital video disks, biological storage, etc. In one embodiment, memory 330 stores operating system 335, which provides system level software to be executed by processor 310 to control electronic system 300. Operating system 335 can be any operating system known in the art or an application-specific operating system.

Memory 330 further includes management application 337 which interacts with one or more components of electronic system 300 to provide functionality for a service establishment. For example, if the service establishment is a restaurant, management application 337 can provide functionality for tracking tables, customers, wait staff, kitchen inventories, gross revenue, hourly profit/loss, etc. In one embodiment, management application 337 maintains a list of waiting customers (“wait-list”) and either stores or generates an estimated wait time for the waiting customers.

Electronic system 300 further includes scheduling agent 110 that can be any combination of software stored in memory 330 and/or hardware coupled with bus 305 or other component of electronic system 300. Scheduling agent 110 operates as described above to track customer location data and other factors to determine customer availability, and to provide service availability information based at least in part on the customer availability. In one embodiment, scheduling agent 110 operates using network interface 350 to provide scheduling information to and receive customer location data and/or other data from a remote wireless service provider. In an alternate embodiment the scheduling agent receives data directly from the customer. In an alternate embodiment, scheduling agent 110 includes a dedicated interface (e.g., a wireless network interface) to provide scheduling information to the remote wireless service provider. In a further embodiment, the wireless service provider is incorporated into the service establishment.

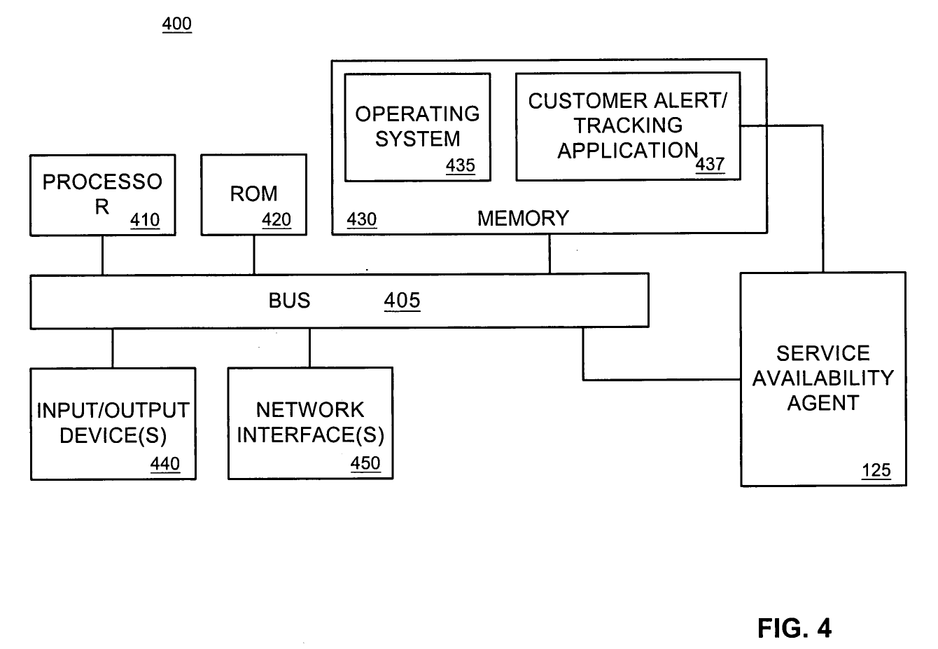

FIG. 4 illustrates a block diagram according to one embodiment of an electronic system having a service availability agent that can be used by a service establishment to provide service availability information to a customer via a wireless device. The electronic system illustrated in FIG. 4 is intended to represent a range of electronic systems including, for example, computer systems. Alternative electronic systems can include more, fewer and/or different components.

In one embodiment, electronic system 400 is located in a wireless service provider facility. The electronic system of FIG. 4 can be, for example, a computer system in a network node of the wireless service provider that processes information received from a service establishment for forwarding and/or otherwise communicating with the wireless device corresponding to the waiting customer. Electronic system 400 includes bus 405 or other communication device to communicate information, and processor 410 coupled to bus 405 to process information. While electronic system 400 is illustrated with a single processor, electronic system 400 can include multiple processors and/or co-processors. Electronic system 400 further includes read-only memory (ROM) or other static storage device 420, coupled to bus 400.

Electronic system 400 further includes input/output (I/O) device(s) 440 for receiving input data and/or signals and for providing output signals. I/O device(s) 440 can include, for example, a keyboard, a mouse, a touch screen, a liquid crystal display, a cathode ray tube, a wireless interface, or any other type of I/O device known in the art. Input may be received through an I/O link with another machine, a virtual reality environment, and biometric feedback. Network interface(s) 450 provides an interface to one or more networks (not shown in FIG. 4) that are external to electronic system 400. Network interface(s) 450 can be, for example, an Ethernet interface, or a wireless local area network interface. Electronic system 400 also includes memory 430 coupled with bus 405. As discussed above for FIG. 3 memory 330, memory 430 can include any state preserving medium. In one embodiment, memory 430 stores operating system 435, which provides system level software to be executed by processor 410 to control electronic system 400. Operating system 435 can be any operating system known in the art or an application specific operating system.

Memory 430 further includes customer alert/tracking application 437 which interacts with one or more components of electronic system 400 to provide functionality for a wireless service provider. For example, if the wireless service provider is a cellular telephone service provider, customer alert/tracking application 437 can provide functionality for tracking customer location, providing an indication of estimated wait time, estimating travel time, etc. In one embodiment, the wireless service provider also monitors other data, such as traffic conditions, weather conditions, and other conditions that may affect customer availability and/or represent the obstacles discussed above for customers. Results of the monitoring may be provided to the service establishment to assist with managing a wait-list for services or other service establishment resources. In another embodiment, this monitoring is performed by the service establishment itself. In another embodiment, the customer (or associated device) monitors for some or all of the events affecting the customers' availability and provides results of the monitoring to the service establishment.

Electronic system 400 further includes service availability agent 125 that can be any combination of software stored in memory 430 and/or hardware coupled with bus 405. Service availability agent 125 operates as described above to provide service availability information related to waiting customers. In one embodiment, service availability agent 125 operates using network interface 450 to receive scheduling information to a remote service establishment. In an alternate embodiment, scheduling agent 110 includes a dedicated interface (e.g., a wireless network interface) to provide scheduling information to the remote wireless service provider.

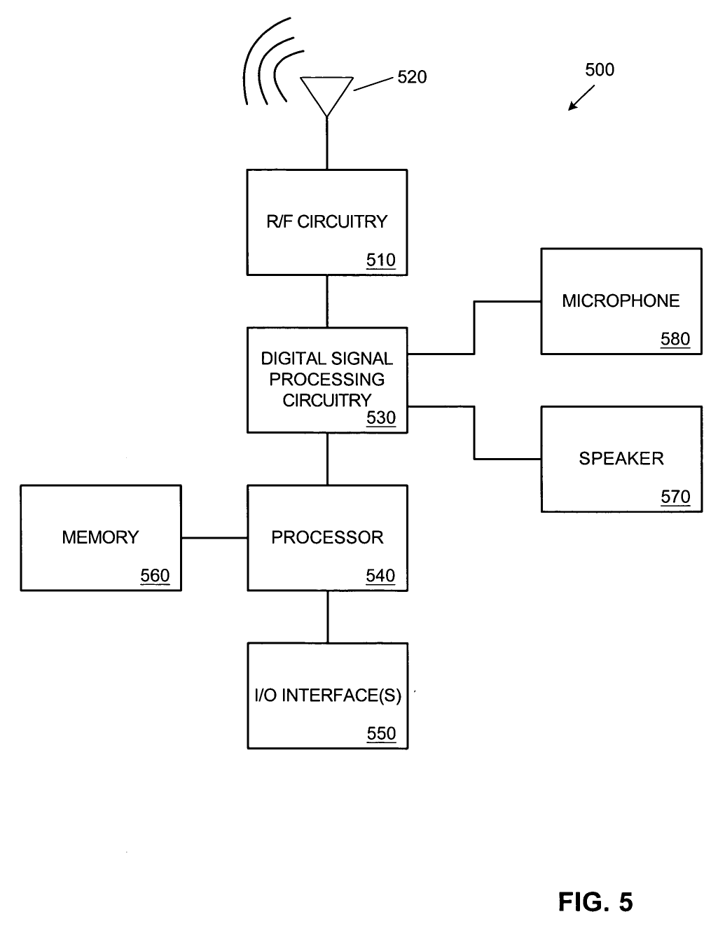

FIG. 5 illustrates a block diagram of a wireless device according to one embodiment. Wireless device 500 may be any type of wireless device that allows a user to communicate with a remote device using wireless protocols. For example, as discussed above, wireless device 500 can be a cellular telephone, a cellular-enabled personal digital assistant, a cellular-enabled automobile, watch, pager, etc.

In one embodiment, wireless device 500 may include processor 540 that provides processing functionality to support operation of the wireless device. Processor 540 may be coupled with input/output (I/O) interface(s) 550 that allow a user of wireless device 500 to provide and receive information. For example, I/O interface(s) 550 may be coupled with a keypad and/or a display device. Processor 540 may also be coupled with memory 560, which as discussed above for FIG. 3 memory 330, memory 430 can include any state preserving medium. Memory 560 can provide storage for instructions executed by processor 540 as well as data.

In one embodiment, processor 540 may be coupled with digital signal processor (DSP) circuitry 530. DSP circuitry 530 can be any type of DSP circuitry known in the art. DSP circuitry 530 may be coupled with speaker 570 and microphone 580 that may be used in transmitting of voice communications. DSP circuitry 530 may be coupled with radio frequency (R/F) circuitry 510 that may be used in receiving and transmitting radio frequency signals using antenna 520, which can be any type of antenna known in the art, for example, one or more omnidirectional antenna(e). One skilled in the art will appreciated that communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

As will be appreciated by one skilled in the art, various embodiments of the invention may be described by reference to or in conjunction with associated data including functions, procedures, data structures, application programs, etc. which when accessed by a machine results in the machine performing tasks or defining abstract data types or low-level hardware contexts. Associated data may be stored in a memory, such as FIG. 3 memory 330. Associated data may be delivered over transmission environments, including network, in the form of packets, serial data, parallel data, propagated signals, etc., and may be used in a compressed or encrypted format. Associated data may be used in a distributed environment, and stored locally and/or remotely for access by single or multi-processor machines.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for scheduling a service of a service establishment, the method comprising:
receiving a first request from a first customer for the service;
adding an entry for the first customer to a wait-list prioritizing service access;
predicting availability of the service;
determining a first estimated time of arrival (ETA) for the first customer based at least in part on a first obstacle to the first customer receiving the service; and
re-arranging the wait-list based at least in part on comparing the predicted availability and the first ETA.

2. The method of claim 1, further comprising:
receiving a second request from a second customer for the service;
adding an entry for the second customer to the wait-list;
determining a second ETA for the second customer based at least in part on a second obstacle to receiving the service; and
re-arranging the wait-list based at least in part on comparing the predicted availability and the second ETA.

3. The method of claim 2, further comprising:
wherein re-arranging the wait-list comprises selected ones of moving the first customer to a lower-priority position on the wait-list, and moving the second customer to a higher-priority position on the wait-list.

4. The method of claim 1, further comprising:
predicting a first customer availability for the first customer; and
determining the first ETA based at least in part on the first customer availability.

5. The method of claim 4, further comprising:
associating with the first customer a device providing location data for the first customer; and
determining the first ETA based at least in part on the location data.

6. The method of claim 5, wherein the device is a portable device.

7. The method of claim 1, further comprising:
associating with the first customer a device providing location data for the first customer; and
determining the first ETA based at least in part on the location data.

8. The method of claim 7, further comprising:
sending an alert to the device, the alert notifying at least of a change in the first customer's priority in the wait-list.

9. The method of claim 7, further comprising:
receiving a status change message from the device;
re-prioritizing the first customer responsive to receiving the status change; and
re-arranging the wait-list based at least in part on said re-prioritizing.

10. The method of claim 1, wherein re-arranging the wait-list comprises moving the first customer to a lower-priority position on the wait-list.

11. The method of claim 1, wherein re-arranging the wait-list comprises moving an other customer to a higher-priority position on the wait-list.

12. A method for scheduling a service of a service establishment, the method comprising:
receiving a first request from a first customer for the service;
adding an entry for the first customer to a wait-list prioritizing service access;
determining a first customer availability for the first customer;
periodically receiving updates to the first customer availability; and
re-arranging the wait-list based at least in part on said updates to the first customer availability.

13. The method of claim 11, further comprising:
receiving a second request from a second customer for the service;
adding an entry for the second customer to the wait-list;
determining a second customer availability for the second customer; and
re-arranging the wait-list based at least in part on both the first and the second customer availability.

14. The method of claim 13, wherein the first and the second customer availability are respectively determined based at least in part on obstacles to the first and second customers receiving the service.

15. A method for scheduling a service of a service establishment for customers having associated devices capable of providing location data for the customers, the method comprising:
receiving a request from a customer for the service;
adding an entry for the customer to a wait-list prioritizing access to the service;
associating the customer's associated device with the wait-list entry;
predicting an availability of the service;
predicting customer availability for selected customers of the wait-list; and
re-arranging the wait-list based at least in part on the predicted service availability and the predicted customer availability.

16. The method of claim 15, wherein predicting customer availability for the customer comprises determining location data for the customer.

17. The method of claim 15, further comprising:
determining estimated times of arrival (ETAs) for said selected customers based at least in part on said predicted customer availability; and
re-arranging the wait-list based at least in part on said ETAs and the predicted availability of the service.

18. A method comprising:
receiving customer information from a party including one or more customers requesting services from a service establishment, the customer information including location data for at least one member of the party;
generating service availability information in response to receiving the customer information; and
providing, to a wireless service provider that provides wireless services to the device corresponding to one of the one or more customers, the service availability information;
periodically receiving updates to said location data; and
periodically updating the service availability to account for said updated location data.

19. The method of claim 18, further comprising:
determining a least available member of the party, said member having a worst customer availability of the customers in the party;
wherein the location data included in the customer information is for the least available member.

20. The method of claim 18, wherein said updates are received from the wireless service provider.

21. The method of claim 18 wherein the wireless device comprises one of: a cellular telephone, a pager, a personal digital assistant (PDA), a portable computer, a global positioning system (GPS) device, a watch, and a wireless electronic mail device.

22. The method of claim 18 wherein the service establishment comprises one of: a restaurant, a hair salon, an automobile service facility, an amusement park attraction, a spa, a bar, a club, a golf course and a bowling facility.

23. The method of claim 18 wherein the customer information comprises one or more of: a number of people in the party, a service preference and a wireless identifier.

24. The method of claim 22 wherein the wireless identifier comprises one of: a cellular telephone number, a pager number, a wireless device network address, a user identifier, a group identifier.

25. The method of claim 18 wherein the service availability information comprises one or more of: an estimated wait time, a distance between the service establishment and the wireless device, a service status, a location of the service establishment and a location of the wireless device.

26. An article comprising a computer-accessible medium having associated therewith instructions for scheduling a service of a service establishment that, when accessed, cause one or more processors to perform:
receiving a first request from a first customer for the service;
adding an entry for the first customer to a wait-list prioritizing service access;
predicting availability of the service;
determining a first estimated time of arrival (ETA) for the first customer based at least in part on a first obstacle to the first customer receiving the service; and
re-arranging the wait-list based at least in part on comparing the predicted availability and the first ETA.

27. The article of claim 26, wherein the associated instructions include further instructions, that, when accessed, cause one or more processors to perform:
receiving a second request from a second customer for the service;
adding an entry for the second customer to the wait-list;
determining a second ETA for the second customer based at least in part on a second obstacle to receiving the service; and
re-arranging the wait-list based at least in part on comparing the predicted availability and the second ETA.

28. The article of claim 26, wherein the associated instructions include further instructions, that, when accessed, cause one or more processors to perform:
associating with the first customer a device providing location data for the first customer; and
determining the first ETA based at least in part on the location data.

29. The article of claim 28, wherein the associated instructions include further instructions, that, when accessed, cause one or more processors to perform:
sending an alert to the device, the alert notifying at least of a change in the first customer's priority in the wait-list.

30. An article comprising a computer-accessible medium having associated therewith instructions for scheduling a service of a service establishment that, when accessed, cause one or more processors to perform:
receiving a first request from a first customer for the service;
adding an entry for the first customer to a wait-list prioritizing service access;
determining a first customer availability for the first customer;
periodically receiving updates to the first customer availability; and
re-arranging the wait-list based at least in part on said updates to the first customer availability.

31. The article of claim 30, wherein the associated instructions include further instructions, that, when accessed, cause one or more processors to perform:
receiving a second request from a second customer for the service;
adding an entry for the second customer to the wait-list;
determining a second customer availability for the second customer; and
re-arranging the wait-list based at least in part on both the first and the second customer availability.

32. An article comprising a computer-accessible medium having associated therewith instructions for scheduling a service of a service establishment for customers having associated devices capable of providing location data for the customers, the instructions, when accessed, causing one or more processors to perform:
receiving a request from a customer for the service;
adding an entry for the customer to a wait-list prioritizing access to the service;
associating the customer's associated device with the wait-list entry;
predicting an availability of the service;
predicting customer availability for selected customers of the wait-list; and
re-arranging the wait-list based at least in part on the predicted service availability and the predicted customer availability.

33. The article of claim 32, wherein the associated instructions include further instructions, that, when accessed, cause one or more processors to perform:
determining estimated times of arrival (ETAs) for said selected customers based at least in part on said predicted customer availability; and
re-arranging the wait-list based at least in part on said ETAs and the predicted availability of the service.

34. An article comprising a computer-accessible medium having associated therewith instructions that, when accessed, cause one or more processors to perform:
receiving customer information from a party including one or more customers requesting services from a service establishment, the customer information including location data for at least one member of the party;
generating service availability information in response to receiving the customer information; and
providing, to a wireless service provider that provides wireless services to the device corresponding to one of the one or more customers, the service availability information;
periodically receiving updates to said location data; and
periodically updating the service availability to account for said updated location data.

35. The article of claim 34, wherein the associated instructions include further instructions, that, when accessed, cause one or more processors to perform:
determining a least available member of the party, said member having a worst customer availability of the customers in the party;
wherein the location data included in the customer information is for the least available member.

36. A system comprising:
a memory controller;
a device for accessing a computer-accessible medium communicatively coupled with the memory controller; and
an article comprising a computer-accessible medium having associated therewith instructions that, when accessed, cause one or more processors to:
receiving a first request from a first customer for the service;
adding an entry for the first customer to a wait-list prioritizing service access;
predicting availability of the service;
determining a first estimated time of arrival (ETA) for the first customer based at least in part on a first obstacle to the first customer receiving the service; and
re-arranging the wait-list based at least in part on comparing the predicted availability and the first ETA.

37. The system of claim 26, wherein the instructions include further instructions that, when accessed, cause one or more processors to:
receiving a second request from a second customer for the service;
adding an entry for the second customer to the wait-list;
determining a second ETA for the second customer based at least in part on a second obstacle to receiving the service; and
re-arranging the wait-list based at least in part on comparing the predicted availability and the second ETA.
